(19) United States
(12) Patent Application Publication
(10) Pub. No.: US 2026/0192298 A1
(43) Pub. Date: Jul. 9, 2026

(54) SAMPLE SECTION HANDLING DEVICE, KIT, AND METHOD, AND USAGE OF THE SAMPLE SECTION HANDLING DEVICE AND KIT

(71) Applicant: Resolve BioSciences GmbH, Monheim am Rhein (DE)

(72) Inventors: Lena-Louise DEPNER, Düsseldorf (DE); Christian KORFHAGE, Langenfeld (DE); Cheng Frank ZHONG, Düsseldorf (DE)

(21) Appl. No.: 19/130,722

(22) PCT Filed: Oct. 30, 2023
(86) PCT No.: PCT/EP2023/080218

§ 371 Date: May 16, 2025

Related U.S. Application Data
(60) Provisional application No. 63/384,246, filed on Nov. 18, 2022.

(51) Int. Cl. B01L 3/00

(52) U.S. Cl. CPC B01L 3/5029; B01L 2200/028; B01L 2200/085; B01L 2300/0645; B01L 2300/0832; B01L 2300/165; B01L 2300/1883

(57) ABSTRACT

The present invention refers to a sample section handling device, a sample section handling kit, a sample section handling method, and the usage of the sample section handling device and kit. According to the present invention, the sample section handling device comprises an elongated body which has a first end formed by a tip portion of the elongated body, and which has a nub formed at the tip portion of the elongated body or formed as the tip portion of the elongated body. The nub has an outer surface that is configured to physically and/or mechanically contact a surface of a sample section for thereby handling and/or manipulating a sample section.

The present invention refers to a sample section handling device, a sample section handling kit, and a sample section handling method, and the usage of the sample section handling device and of the central section handling kit.

In particular, the present invention relates to a device or tool, to a kit or arrangement, and to a method for handling a section of a sample or specimen as well as to the usage of the device or tool and the kit or arrangement in a sample section handling method.

Nowadays, the investigation of sections of samples—the sections being produced by processes of microtomy (with the samples prepared and fixed in formalin and/or paraffin or any other fixing agent combination of fixing agents) and cryotomy (with the samples prepared and fixed by fast freezing)—has become very important. The samples or specimens may for instance originate from a biological material, e.g., but not only, a tissue from a human, from an animal, from a plant, from fungi, from organoids, and/or a biologically produced, grown and/or cultured assembly with or of eukaryotic and/or prokaryotic cells, viral structures or other biological entities and/or combinations and/or parts thereof.

After having prepared such sections as such, the sections have to be manipulated and handled for further investigation, for instance by transferring the same to an investigation stage, for instance to a slide for microscopy, to a multiwell site, or the like.

In case of not directly transferring a sample section to a slide, multiwell site or the like, such a process of manipulation or handling is conventionally performed by an operator using one or plural brushes for picking up, lifting, using forceps for the transfer, and dropping and/or for laterally pushing and thereby transferring the produced sections from the location of their production to a location for their investigation. Such a conventional method can inter alia in general be found in DE 10 2011 016 191 A1, mentioning the usage of brushes and forceps for sample treatment and sample section treatment, as well as in Ross, M. A., Kohut, L., & Loughran, P. A. (2022). Cryosectioning. Current Protocols, Vol. 2, e342, doi: 10.1002/cpz1.342.

The usage of such conventional brushes has a variety of drawbacks, namely as inter alia the tissues cannot be transferred into reaction wells of pre-assembled slides, hairs of the used brushes can damage the tissue, tissue sections more likely occur to arrive on object slides with foldings and/or wrinkles leading to blurriness during microscopy, the transfer with conventional brushes has the risk of changing the tissue morphology, e.g. in connection with lung tissue having many holes, the analysis samples and slides can get contaminated by small hair residues or by residues attached to the hairs of the brush, and cleaning and disinfection of brushes are inconvenient, thus increasing the risk of contamination of the samples with RNases.

The direct transfer of a sample section to a slide, multiwell site or the like, may cause damage of the slide or multiwell structure. In addition, direct transfer does not allow charging of pre-assembled slides.

It is an object underlying the present invention to suggest a sample section handling device, kit, and method which are improved by avoiding the above-mentioned disadvantages.

The object underlying the present invention is achieved by a sample section handling device according to independent claim 1, by a sample section handling kit according to independent claim 12, by usages of the sample section handling device and of the sample section handling kit according to claims 15 and 16, respectively, and by alternative sample section handling methods according to independent claims 17 and 18. Preferred embodiments of the present invention are defined in the respective dependent claims.

According to a first aspect of the present invention, a sample section handling device is proposed which comprises a body and in particular an elongated body having a first end formed by a tip portion of the body or elongated body, and a nub formed at the tip portion of the body or elongated body or formed as the tip portion of the body or elongated body. According to the present invention's gist, the nub has an outer surface that is configured to physically and/or mechanically contact a surface of a sample section for thereby handling and/or manipulating the sample section. According to the present invention, the usage of brushes and hairs is completely substituted and their disadvantages—namely as indicated in more detail above and below—are therefore avoided and turned into corresponding advantages.

The body or elongated body may be formed as a solid body, e.g. as a rod, cantilever, or the like, or as a hollow body, e.g. a pipe, tube, or the like.

According to a preferred embodiment, the body or elongated body may have a second end that is formed by a second end portion of the body or elongated body, and the tip portion and thus the first end of the body or elongated body on the one hand and the second portion and thus the second end of the elongated body on the other hand form opposing ends of the elongated body with a central portion of the elongated body arranged and disposed therebetween.

Under such circumstances, the central portion may be configured for being gripped by gripping means of an operator entity. The gripping means may be some kind of manipulator or actuator or a hand, for instance of a robot or a human operator referred to as entity.

The nub and at least its outer surface may be or may be formed by or may be based on a hollow body, a shell, a jacket, an envelope, a closed sleeve or a hull and in particular, may have essentially a shape of a spherical cap, an ellipsoidal cap, a parabolic cap, in particular in case of being free of external forces.

Additionally or alternatively, the nub and at least its outer surface may be or may be formed to partially or completely have at least one of a convex shape, a concave shape, a round shape, a planar shape, a quadratic shape, a rectangular shape, and a hollow shape of a ring or torus, in particular for low pressure or negative pressure applications.

The nub may comprise an inner surface and a rim, the latter also referred to as a rim portion, a collar or a collar portion.

The outer surface of the nub and the inner surface may be opposed to each other and are connected to each other by said rim, rim portion, collar or collar portion.

The inner surface may face the tip portion of the body or elongated body.

The rim, rim portion, collar or collar portion may at least in part physically and/or mechanically contact and may thus be adjacent to the body or elongated body and/or the tip portion thereof.

Further alternatively or additionally, the nub and at least its outer surface may be or may be formed by or may be based on a material which is at least one of mechanically flexible and/or resilient, electrically conducting, thermally conducting, chemically inert, and wettable. With such measures, the interaction between the surface of the nub and the surface of any sample section may appropriately be designed for achieving the desired handling and manipulation properties, in particular for transport by means of vertical and/or transversal transfer. This may of course be done by taking into consideration the properties of the surface of the sample section.

Although during the application and depending (i) on the application scenario, the concrete nature (i) of the sample and sample section and (iii) of the test site and its geometry, the body or elongated body may be inclined to some extent with respect to the surface of the sample section and/or the test site, a vertical or an essentially vertical orientation is preferred in certain application modes.

According to another advantageous improvement of the present invention, the nub and at least its outer surface may be or may be formed by or may be based on a material which is or which comprises at least one of a rubber material, a silicone material, a polymer material, a plastic or synthetic material, an elastomer material, a material coated with or having incorporated a metal material, in particular aluminum, woven material, a woven tissue material, a hybrid material, in particular having various segments, a hybrid mixed material, a heat conductive material, an electrically conductive material, a gas or air permeable material, a hydrophilic material, a hydrophobic material, a coated material, a structured and/or textured material, in particular offering at least one of a corrugated surface, dotted surface and meshed surface, and a material having properties of surface roughness, friction or friction coefficients, adhesion, wettability, and/or flexibility which are adapted and suitably and appropriately set for (a) vertically transferring, in particular by lifting/dragging and dropping, and/or for (b) laterally transferring, in particular by pushing, a sample section.

Preferably, in certain embodiments of the present invention's sample section handling device, at least one of biasing and/or resilient means for limiting mechanical pressure and/or force exerted by the nub on a sample section upon physical and/or mechanical contact, releasing means for releasing a physical and/or mechanical contact of the nub to a sample section, charge setting means for controllably setting and in particular removing and/or compensating an electrical charge on the nub, on the outer surface of the nub, and/or on a sample section and its surface in physical and/or mechanical contact with the nub, and thermal setting means for controllably cooling and/or heating the nub, the outer surface of the nub, and/or a sample section in physical and/or mechanical contact with the nub. With such means, the invention's manipulation capabilities are improved, in particular in view of a desired careful, smooth, and gentle handling of the sample sections.

Under such circumstances, actuator and/or operating means make sense, in particular for controllably operating at least one of the biasing and/or resilient means, the releasing means, the discharging means, and the thermal setting means.

According to a further preferred embodiment of the present invention's sample section handling device, the body or elongated body comprises at least one of:
cylindrical shape,
a shape having a polygonal or rectangular cross section,
a hollow body,
a filled body,
a length that is adapted or adaptable in its length, in particular depending on a desired application and/or function,
an ergonomically adapted or adaptable shape,
a material that is at least one of solid, rigid, shapeable,
a polymer material,
a plastic or synthetic material,
a metal material,
a wood or wooden material,
a glass material, and/or

Still according to a further preferred embodiment of the present invention's sample section handling device, is configured to be at least one of:
thermally adapted or adaptable, in particular to be cooled,
controlled or controllable by means of pressurized gas or air, in particular with a hollow inner portion and an open tip end and/or with a pipette-function,
controlled/operated or controllable/operable by electrical means and/or by means of an inverter,
controlled or controllable by means of an elastic or spring-loaded element, in particular arranged in an inner hollow portion,
filled or fillable with a fluid or liquid for thermal adaptation, in particular for cooling, and
filled or fillable with an aqueous solution, in particular for delivering and/or accepting a drop of solution and a sample section and/or for a formalin-fixed paraffin-embedded environment.

In the sample section handling device according to a further additional or alternative embodiment of the present invention, the first end and/or the tip portion of the elongated body may comprise a restriction guide which is configured in order (i) to fit into an investigation site and in particular into an inner dimension of a well and/or (ii) to direct the sample section handling device or at least its first end and/or its tip portion to place a sample section at an investigation site and in particular at a center of a well. In other words, the sample handling device's tip may have a restriction guide in order to fit into the inner dimension of the underlying wells. The guide can direct the handling device to place a sample section at a center of a well.

In still a further additional or alternative embodiment of the section handling device according to the present invention, the first end and/or the tip portion of the elongated body is or comprises a removable or replaceable member. The sample handling device's tip according to this embodiment can be removed and replaced with a new one. A single tip is in contact with only a single removable tip in order to avoid cross contamination from a reused tip.

The present invention further relates to a sample section handling kit. The present invention's sample section handling kit comprises a sample section handling device according to any one of the preceding claims, and a storage means which is configured to receive and/or to release the sample section handling device, in particular in a controllable manner and/or by having receptacle means.

Preferably and according to a first preferred embodiment of the sample section handling kit, a thermal setting means is formed which is configured to cool and/or heat the sample section handling device, in particular its first end, its tip portion, its nub and/or its outer surface and/or in a controllable manner, and which in particular is a component of the receptacle means.

Additionally or alternatively, charge setting means may be comprised, which is configured to set and in particular to remove and/or to compensate an electrical charge on the first end of the elongated body, on its tip portion, on the nub, on the outer surface of the nub, and/or in a controllable manner, and which in particular is a component of the receptacle means.

Furthermore, the present invention further proposes the usage of a sample section handling device, in particular in a method of handling a sample section 10, wherein the sample section handling device as such is formed according to the present invention and its embodiments, and wherein the method of handling a sample section comprises at least one of (a) vertically transferring, in particular by lifting/dragging and dropping, and of (b) laterally transferring, in particular by pushing, a sample section.

Alternatively, a usage of a sample section handling kit, in particular in a method of handling a sample section, is proposed, wherein the sample section handling kit is formed according to any one of the present invention's embodiments and wherein the method of handling a sample section comprises at least one of (a) vertically transferring, in particular by lifting/dragging and dropping, and of (b) laterally transferring, in particular by pushing, a sample section.

Also, a sample section handling method is suggested by the present invention and comprises at least one of (a) vertically transferring, in particular by lifting/dragging and dropping, and of (b) laterally transferring, in particular by pushing, a sample section. In the present invention's method, at least one of a sample section handling device according to the present invention's gist and a sample section handling kit according to the present invention's embodiments are used for said at least one of (a) vertically transferring, in particular by lifting/dragging and dropping, and of (b) laterally transferring, in particular by pushing, a sample section.

According to an alternative view of the present invention's sample section handling method, the proposed method comprises at least one of (i) supplying and preparing sample section at and/or to a first location, and (ii) transferring the sample section from the first location to a second location, which is in particular spatially separated from the first location. In such a method according to the present invention said transferring comprises at least one of (a) vertically transferring, in particular by lifting/dragging and dropping, and of (b) laterally transferring, in particular by pushing, a sample section by using at least one of a sample section handling device according to an embodiment of the present invention and a sample section handling kit also according to an embodiment of the present invention.

These and further details, advantages and features of the present invention will be described based on embodiments of the invention and by taking reference to the accompanying figures.

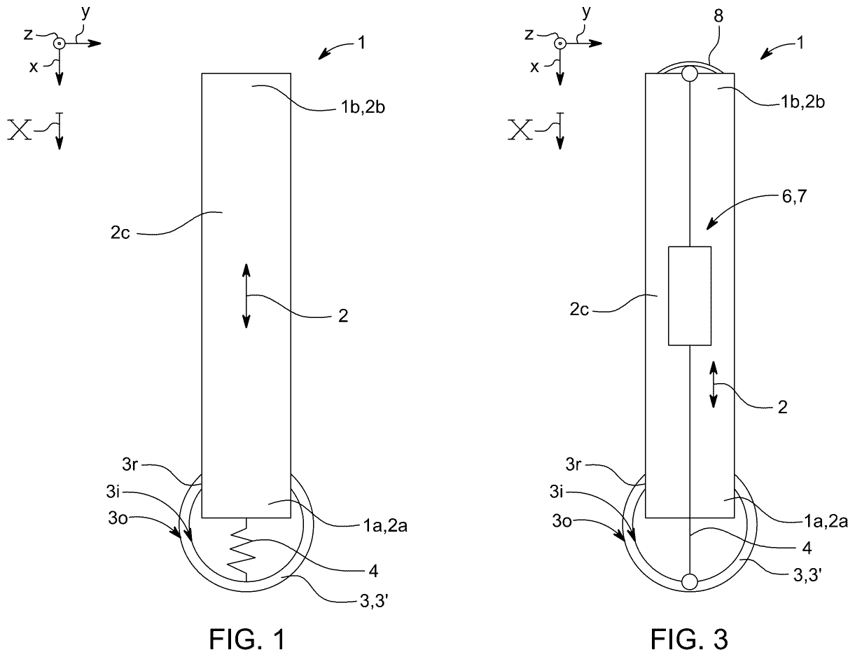

FIG. 1 is a cross sectional side view of a first embodiment of the sample and/or specimen section handling device and/or tool according to the present invention, wherein the device comprises a first kind of resilient and/or biasing means.

FIGS. 2A and 2B are cross sectional side views of a second embodiment of the sample and/or specimen section handling device and/or tool according to the present invention, wherein the device comprises releasing means for releasing a sample section attached to the tip portion of the device.

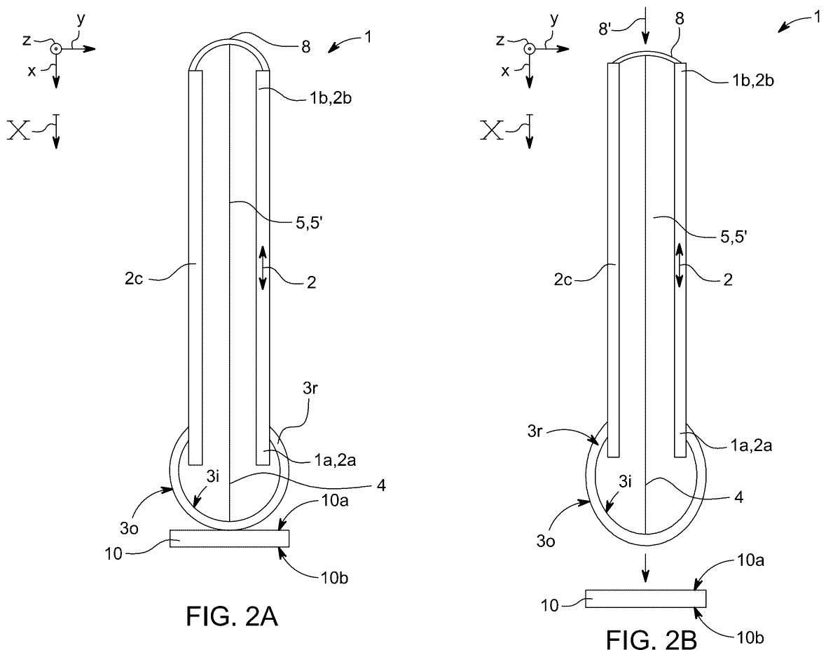

FIG. 3 is a cross sectional side view of a third embodiment of the sample and/or specimen section handling device and/or tool according to the present invention, wherein the device comprises charge setting and/or thermal setting means.

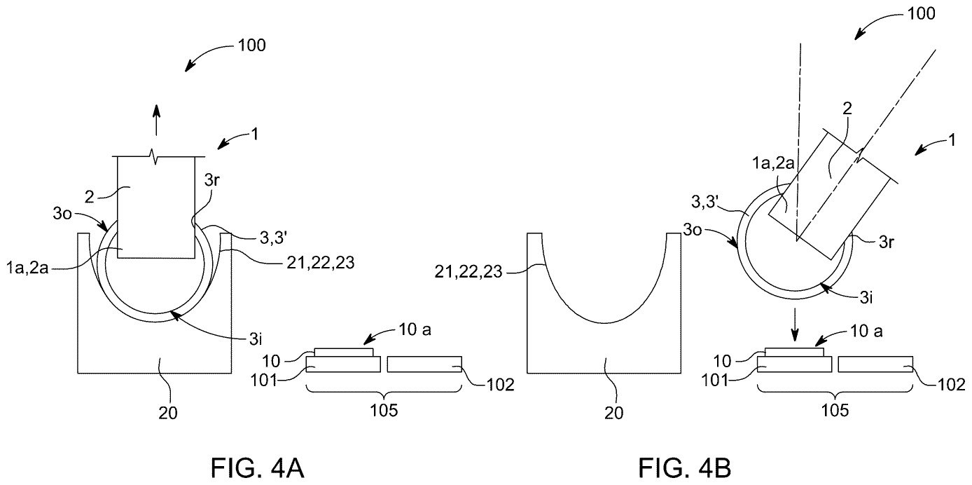

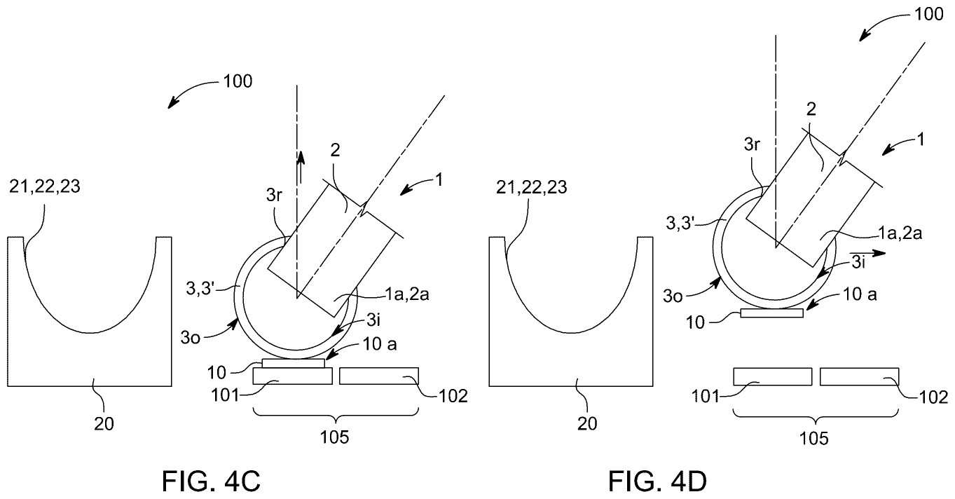

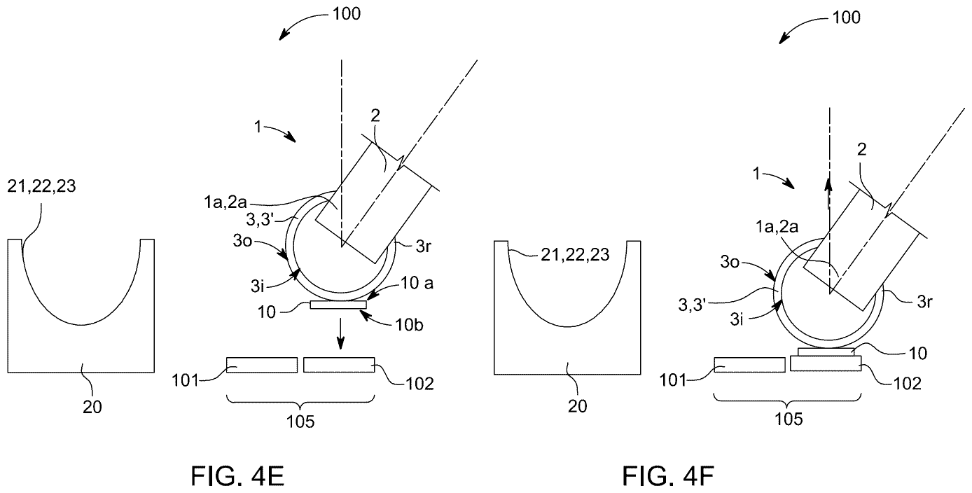

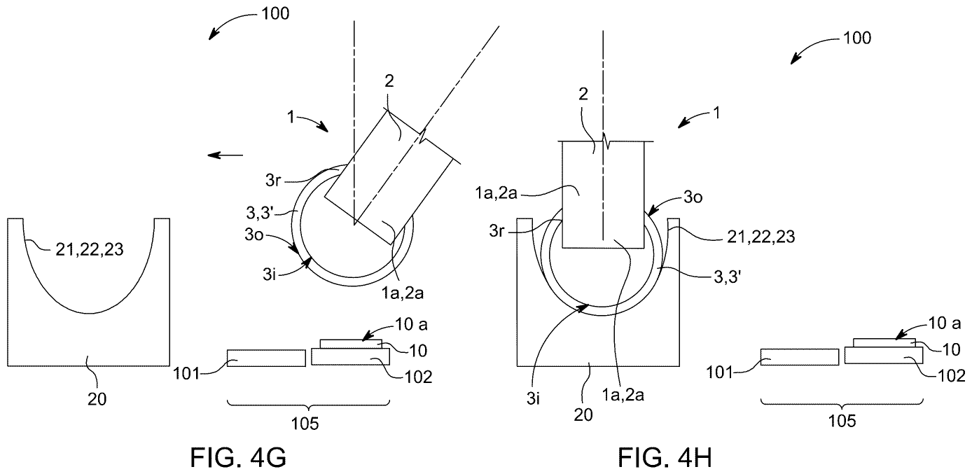

FIGS. 4A to 4H elucidate by means of cross-sectional side views the usage of embodiments of the present invention's sample and/or specimen section handling device and/or tool and kit in a first embodiment of a sample section handling method according to the present invention, namely with a focus on vertically lifting and transferring a sample section attached to a tip portion of the underlying sample section handling device.

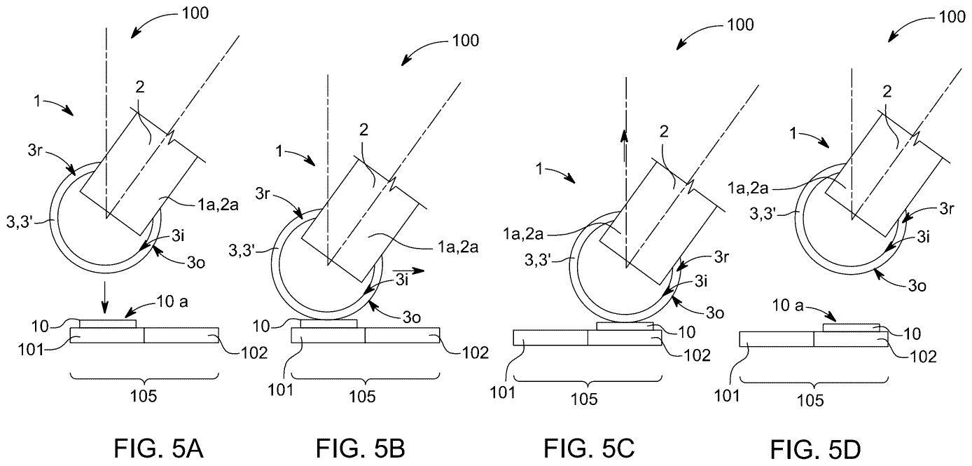

FIGS. 5A to 5D elucidate by means of cross-sectional side views the usage of embodiments of the present invention's sample and/or specimen section handling device and/or tool and kit in a second embodiment of a sample section handling method according to the present invention, namely with a focus on just laterally transferring a sample section attached to a tip portion of the underlying sample section handling device, i.e. without vertically lifting the attached sample section.

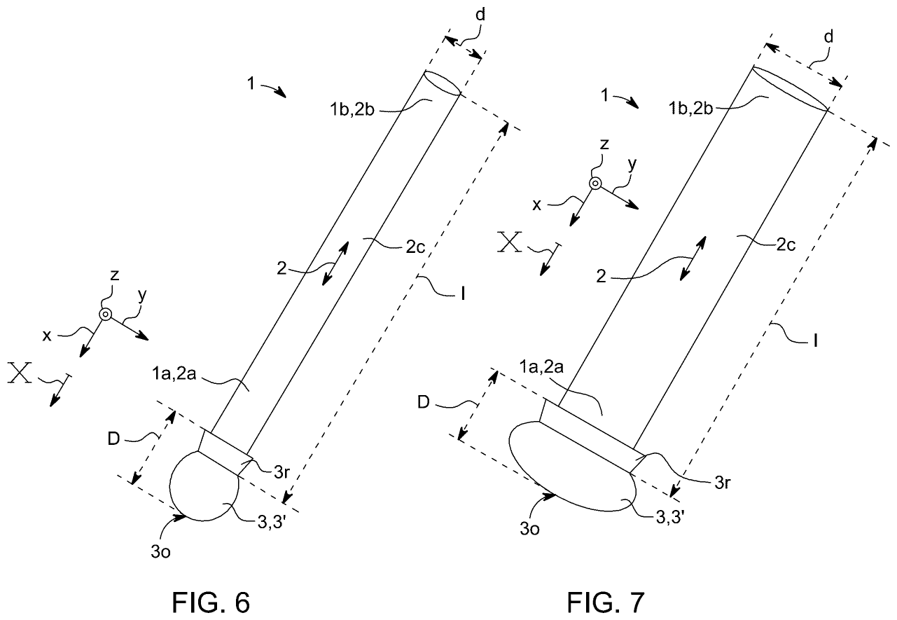

FIG. 6 is a perspective side view of a fourth embodiment of the sample and/or specimen section handling device and/or tool according to the present invention, the device comprising a comparable small nub.

FIG. 7 is a perspective side view of a fifth embodiment of the sample and/or specimen section handling device and/or tool according to the present invention, the device comprising a comparable large nub.

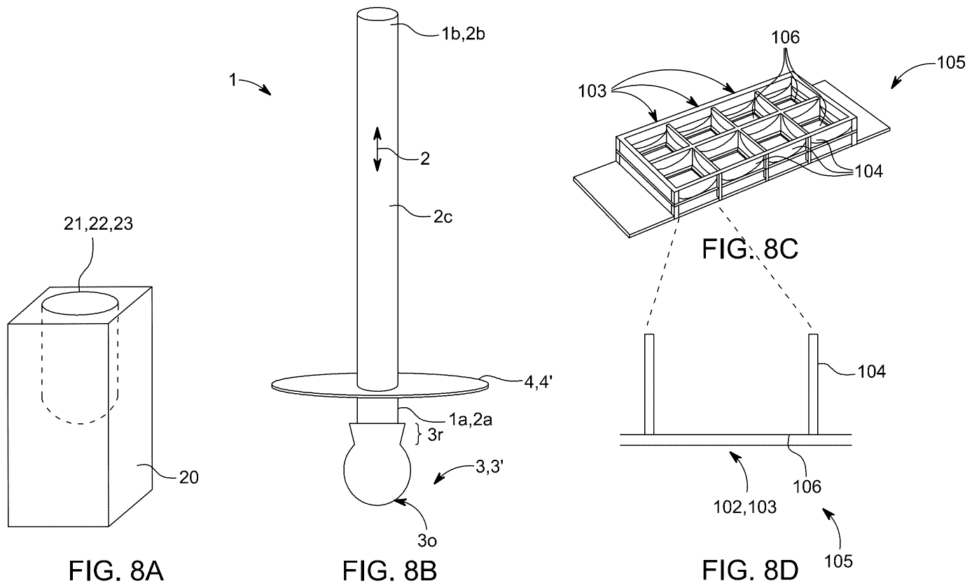

FIGS. 8A to 8D illustrate by means of perspective side views a sample section handling kit, wherein the present invention's underlying sample section handling device comprises a second kind of resilient means as an alternative for restricting pressure and force exerted on the sample section and/or an investigation stage or side.

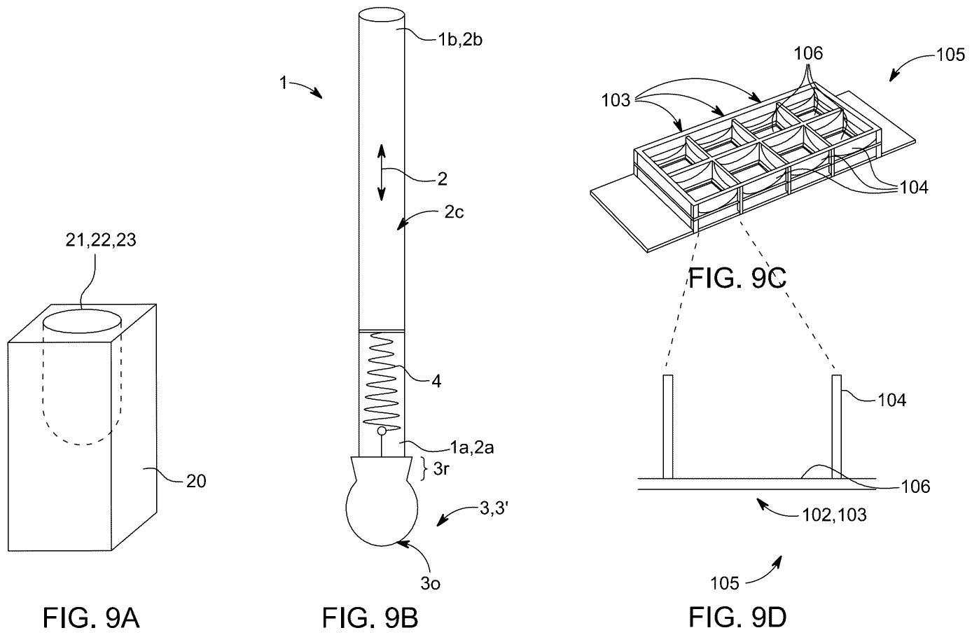

FIGS. 9A to 8D illustrate by means of perspective side views a sample section handling kit, wherein the present invention's underlying sample section handling device comprises resilient means for restricting pressure and force exerted on the sample section and/or an investigation stage or side, wherein the resilient means is comparable to some extent to that as shown in FIG. 1.

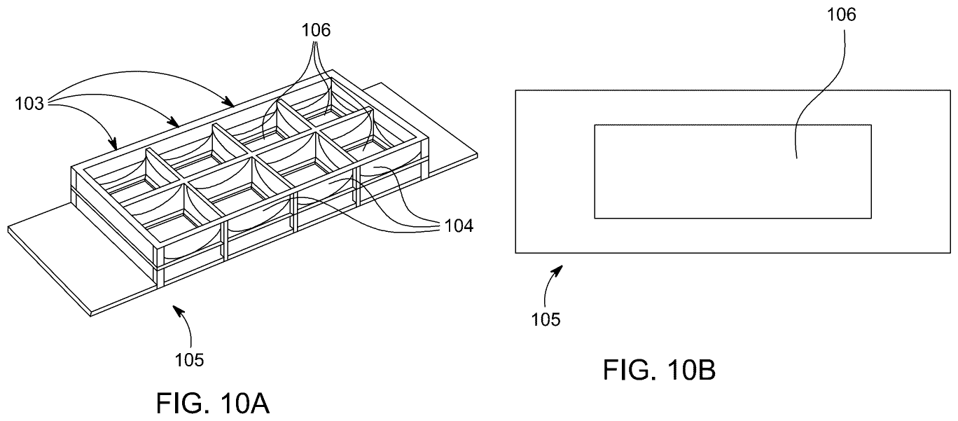

FIGS. 10A and 10B illustrate by means of a perspective side view and a plan view, respectively, properties of an investigation site for providing a smooth and temperature-controlled surface for improved and stable sample section transfer.

In the following embodiments and the technical background of the present invention are presented in detail by taking reference to accompanying FIGS. 1 to 10. Identical or equivalent elements and elements which act identically or equivalently are denoted with the same reference signs. Not in each case of their occurrence a detailed description of the elements and components is repeated.

The depicted and described features and further properties of the invention's embodiments can arbitrarily be isolated and recombined without leaving the gist of the present invention.

In the following and first of all, a preliminary and very general view is taken on the enclosed figures, with a particular focus on FIGS. 1 to 5D:

As shown in the FIGS. 1 to 5D in general, a sample section handling device 1 according to the present invention comprises a body 2 and in particular an elongated body 2 having a first end 1a formed by a tip portion 2a of the body 2 or elongated body 2, and a nub 3 formed at the tip portion 2a of the body 2 or elongated body 2 or formed as the tip portion 2a of the body 2 or elongated body 2.

According to the present invention's gist, the nub 3 has an outer surface 30 configured to physically and/or mechanically contact a surface 10a of a sample section 10 for thereby handling and/or manipulating the sample section 10, in particular for transfer or transport.

According to the present invention, the conventional usage of brushes is completely substituted and their disadvantages—namely as indicated in more detail above and below—are therefore avoided and turned into corresponding advantages.

The body 2 or elongated body 2 may be formed as a solid body as shown in FIG. 1, for instance as a rod, a cantilever or the like. These measures offer a particularly high degree of strength, stability, and handling convenience.

In FIGS. 1 to 3, the elongated body 2 has a direction X which is parallel to the x direction in the external frame of reference xyz.

Alternatively to the situation of FIG. 1 and as shown in connection with FIGS. 2 and 3, a pipe, a tube or the like—i.e. any hollow body—may be used as said elongated body 2 in order to form the main portion of the sample section handling device 1 according to the present invention. These measures offer the possibility of storing and housing additional operation means in an inside portion of the body 2 and of reducing weight.

The body 2 has a second end 1b that is formed by a second end portion 2b of the body 2. The tip portion 2a and thus the first end 1a of the body 2 and the second portion 2b and thus the second end 1b of the body 2 are formed in opposition to each other and define opposing ends of the body 2.

A central portion 2c of the body 2 is arranged and disposed between the opposing ends 1a, 2a and 1b, 2b. The central portion 2c may be gripped by gripping means formed by a gripping manipulator or actuator of a robot or by a physical hand of a human operator, the robot and alternatively the human operator forming an operator entity in the sense of the present invention.

According to an alternative view on and explanation of the present invention's gist, a sample section handling device 1 is suggested which comprises a body 2 which might be formed as an elongated body 2 and which has a first end 1a that is formed by a tip portion 2a of the body or elongated body 2 and also has a second end 1b that is formed by a second end portion 2b of the body or elongated body 2. In addition, according to this alternative view of the present invention's gist, a nub 3 is formed at or as the tip portion 2a of the body or elongated body 2. The tip portion 2a and the second portion 2b form opposing ends of the body or elongated body 2 with a central portion 2c of the elongated body 2 located in extending therebetween. The central portion 2c may be configured for being gripped by an operator entity. The nub 3 may have an outer surface 30 that is configured to physically and/or mechanically contact a surface 10a of a provided sample section 10 for thereby handling and/or manipulating a sample section 10.

As further shown in the FIGS. 1 to 5D in general, the nub 3 and at least its outer surface 30 may be or may be formed by or based on a hollow body, a shell, a jacket, an envelope, a closed sleeve or a hull and in particular essentially has as a shape of a spherical cap, an ellipsoidal cap, a parabolic cap, in particular in case of being free of external forces. Therefore, the nub 3 comprises an inner surface 3i and a rim 3r. The outer surface 30 of the nub 3 and the inner surface 3i are opposed to each other and they are connected to each other by said rim 3r. The inner surface 3i faces the tip portion 2a of the body 2 or elongated body 2. The rim 3r is physically and/or mechanically in contact with and thus located in an adjacent manner to the body 2 and the tip portion 2a thereof.

As already indicated above, the nub 3 and at least its outer surface 30 may be or may be formed by or based on a material which is at least one of mechanically flexible and/or resilient, electrically conducting, thermally conducting, chemically inert, and wettable. With such measures the interaction between the surface 30 of the nub 3 and the surface 10a of any sample section 10 may appropriately be designed for achieving the desired handling and manipulation properties, in particular for transport by means of vertical and/or transversal transfer. This may of course be done by taking into consideration the properties of the surface 10a of the sample section 10.

The nub 3 and at least its outer surface 30 may be or may be formed by or based on a material 3′ which is or which comprises at least one of a rubber material, a silicone material, a polymer material, a plastic or synthetic material, and a material having properties of surface roughness, friction, adhesion, wettability, and/or flexibility which are adapted and suitably and appropriately set for (a) vertically transferring, in particular by lifting/dragging and dropping, and/or for (b) laterally transferring, in particular by pushing, a sample section 10.

As indicated in FIG. 1, the present invention's sample section handling device 1 may comprise biasing and/or resilient means 4 for limiting mechanical pressure and/or force exerted by the nub 3 on a sample section 10 an investigation site 105 upon physical and/or mechanical contact. The biasing and/or resilient means 4 may be a compressible spring with a certain given and/or adjustable spring constant. Any compressible material may serve as a resilient means 4, too, e.g. a gas volume stored inside the body 2 or in a compartment thereof may be used.

According to FIGS. 2A and 2B, releasing means 5 can be formed for releasing a physical and/or mechanical contact and/or attachment of the nub 3 to a sample section 10. Similar means as for the resilient means may be used for or as a part of the releasing means 5. In FIG. 2, the releasing means 5 is indicated as comprising a rod 5′ which can be operated by exerting a pressure 8′ or force 8′ to the rod 5′ via the actuator 8. Such an operation at least locally alters the shape of the nub 3 and of its outer surface 30, thereby terminating the attachment of any attached sample section 10 and thus releasing the same from the nub 3.

As shown in FIG. 3, charge setting means 6 can be installed for controllably setting and in particular removing and/or compensating an electrical charge on the nub 3, on the outer surface 30 of the nub 3, and/or on a sample section 10 and its surface 10a in physical and/or mechanical contact with the nub 3. For instance, the nub 3 may comprise an electrically conducting material and may be connected to an internal or external electric charging circuit, e.g. by electrically contacting the inner surface 3i of the nub 3. In a preferred embodiment, the inner surface 3i of the nub 3 may be electrically connected to a ground potential.

Additionally or alternatively, thermal setting means 7 for controllably cooling and/or heating the nub 3, the outer surface 30 of the nub 3, and/or a sample section 10 in physical and/or mechanical contact with the nub 3. This is also indicated by means of FIG. 3. For instance, the nub 3 may comprise a thermally conducting material and may be connected to a thermal setting unit, e.g. by using controllable Peltier elements or the like in the nub 3 or in thermal contact with the nub 3 and its inner surface 3i. A heat bath unit may be involved, too.

Under such circumstances as shown in FIGS. 2A, 2B, and 3, actuator and/operating means 8 may be formed, in particular for controllably operating at least one of the releasing means 5, the discharging means 6, and the thermal setting means 7.

The present invention's sample section handling kit 100 may be designed according to the sequence of FIGS. 4A to 4G and—in this embodiment—may comprise a sample section handling device 1 according to any one of the present invention's embodiments as well as a storage means 20 which is configured to receive and/or to release the sample section handling device 1, in particular in a controllable manner and/or by having receptacle means 21. The storage means 20 therefore inter alia serves as a stand for the sample section handling device 1; this also applies to the embodiments as shown in FIGS. 8 and 9 as described below.

The sample section handling kit 100 may also be referred to as a sample section handling system or arrangement and may comprise a thermal setting means 22 which is configured to cool and/or heat the sample section handling device 1, in particular its first end 1a, its tip portion 2a, its nub 3 and/or its outer surface 30 and/or in a controllable manner, and is a component of the receptacle means 21.

Additionally or alternatively, charge setting means 23 may also be formed, which is configured to set and in particular to remove and/or to compensate an electrical charge on the first end 1a of the elongated body 2, on its tip portion 2a, on the nub 3, on the outer surface 30 of the nub 3, and/or in a controllable manner, and is a component of the receptacle means 21.

As shown in the sequence of FIGS. 4A to 4H and 5A to 5D, different modes of usage or use of a sample section handling device 1 in a method of handling a sample section 10 may be designed, wherein the sample section handling device 1 as such is formed according to the present invention and its embodiments, and wherein the method of handling a sample section 10 comprises at least one of (a) vertically transferring, in particular by lifting/dragging and dropping, and of (b) laterally transferring, in particular by pushing, a sample section 10.

According to an alternative view on the usage or use of a sample section handling kit 100 according to the present invention in a method of handling a sample section 10, the sample section handling kit 100 is formed according to any one of the present invention's embodiments and the method of handling a sample section 10 comprises at least one of (a) vertically transferring, in particular by lifting/dragging and dropping, and of (b) laterally transferring, in particular by pushing, a sample section 10.

As already indicated above, during the application and depending (i) on the application scenario, the concrete nature (i) of the sample and sample section and (iii) of the test site and its geometry, the body or elongated body may be inclined to some extent with respect to the surface of the sample section and/or the test site. This angle may be varied in order to achieve improvements.

Under particular circumstances, a vertical or an essentially vertical orientation is preferred for certain modes of application. In other words, under such circumstances the inclination angle between the longitudinal axis of the sample section handling device 1 or its elongated body 2 and the normal of the surface of the sample section 10 is set to be 0° or to be a value which sufficiently near to 0° and which thus suitable for the concrete application scenario in question.

By again taking reference to the sequence of FIGS. 4A to 4H, a sample section handling method as suggested by one of the present invention's embodiments may comprise at least one of (a) vertically transferring, in particular by lifting/dragging and dropping, and of (b) laterally transferring, in particular by pushing, a sample section 10. In the present invention's method, at least one of a sample section handling device 1 according to the present invention's embodiments and a sample section handling kit 100 according to the present invention's embodiments are used for said at least one of (a) vertically transferring, in particular by lifting/dragging and dropping, and (b) laterally transferring, in particular by pushing, a sample section 10.

According to an alternative view of the present invention's sample section handling method, the proposed method comprises at least one of supplying and preparing sample section 10 at and/or to a first location 101 and transferring the sample section 10 from the first location 101 to a second location 102, which is in particular spatially separated from the first location 101. In such a method according to the present invention said transferring comprises at least one of (a) vertically transferring, in particular by lifting/dragging and dropping, and (b) laterally transferring, in particular by pushing, a sample section 10 by using at least one of a sample section handling device 1 according to an embodiment of the present invention and a sample section handling kit 100 also according to an embodiment of the present invention.

A possible processing scheme of the present invention's sample section handling method can be understood based on the sequence of FIGS. 4A to 4H as follows:

In the state as shown in FIG. 4A, the present invention's sample section handling device 1 is received in the receptacle 21 of the storage means 20 of the underlying sample section handling kit 100. In the receptacle 21, the nub 3 of the sample section handling device 1 may be set with respect to its temperature and its charging state by means of a thermal setting means 22 which might be a cooling means, and by a charge setting means 23, respectively.

In the transition from the situation as shown in FIG. 4A to the situation as shown in FIG. 4B, the sample section handling device 1 is removed from the receptacle 21 and maneuvered directly above but still spatially separated from a sample section 10 which is placed at a first location 101 of an investigation site 105.

In the transition to the situation as shown in FIG. 4C, the sample section handling device 1 and its nub 3 approach the upper surface 10a of the sample section 10 and physically and/or mechanically contact the same in order to establish an attachment of the sample section 10 to the outer surface 30 of the nub 3 via its lower surface 10b.

Then, as shown in FIG. 4D, and after having vertically moved the sample section handling device 1 and the nub 3 along the arrow as shown in FIG. 4C, the handling device 1 and the nub 3 are vertically separated from the investigation site 105 and its location 101 having attached the sample section 10 to the outer surface 30 of the nub 3.

After having moved the present invention's handling device 1 along the arrow as shown in FIG. 4D right above the second location 102 of the investigation site 105 but still vertically and spatially separated therefrom, a situation as shown in FIG. 4E is obtained.

Then and following the arrow indicated in FIG. 4E, the present invention's sample section handling device 1 with the sample section 10 attached to the outer surface 30 of the nub 3 approaches the upper surface of the investigation site 105 at the second location 102 in order to get into attachment with said upper surface of the investigation site 105, namely as shown in FIG. 4F.

Then following the arrow as shown in FIG. 4F, the present invention's sample section handling device 1 is retracted after having released the attachment of the upper surface 10a of the sample section 10 from the outer surface 30 of the nub 3. This situation is shown in FIG. 4G.

After that, the present invention's sample section handling device 1 may be restored in the receptacle 21 of the storage means 20 of the present invention sample section handling kit 100.

As a final result, the sample section 10 has been transferred from the first location 101 of the investigation site 105 to a spatially separated second location 102. According to the present invention, this has been done with a higher degree of reliability and of conserved properties of the sample section 10.

In a similar manner, the sequence of FIGS. 5A to 5D demonstrates the pure lateral transfer of the sample section 10—i.e. without vertical lift—from a first location 101 of the investigation site 105 to a second location 102 thereof, for instance just by pushing and thereby sliding said sample section 10 from the first location 101 to the second location 102, in particular without leaving the surface of the investigation site 105.

FIG. 6 is a perspective side view of a fourth embodiment of the sample and/or specimen section handling device 1 and/or tool 1 according to the present invention, wherein the device comprises a comparable small nub 3, the nub having a diameter D of about 0.5 cm to 0.8 cm and the body 2 having a diameter d of about 0.5 cm to 1.0 cm.

In contrast thereto, FIG. 7 is a perspective side view of a fifth embodiment of the sample and/or specimen section handling device 1 and/or tool 1 according to the present invention, wherein the device comprises a comparable large nub 3, the nub 3 having a diameter D of about 1.5 cm to 2.0 cm and the body 2 having a diameter D of about 1.5 cm to 2.0 cm.

In both cases of FIGS. 6 and 7, the length l of the body 2 may be in the range of 5 cm to 13 cm.

In addition, the inner and the outer surfaces 3i and 30 of the nubs 3 as shown in FIGS. 6 and 7 are connected by a rim portion 3r of the nub 3 which is formed as an additional collar formed in a frustoconical shape getting wider in its opening with increasing distance from the center of the nub 3. Such a shape enhances the attachments of the nub 3 to the first end 1a or tip portion 2a of the elongated body 2.

FIGS. 8A to 8D illustrate by means of perspective side views a sample section handling kit 100 with a storage means 20 serving as a stand, wherein the present invention's underlying sample section handling device 1 comprises an alternative resilient means 4′ for restricting pressure and force exerted on the sample section and/or an investigation stage 105 or site 105.

The alternative embodiment of the resilient or biasing means for is formed as a circumferential protection plate 4′ that is situated in a particular distance S from the most distant apex A of the nub 3 and it is configured in order to abut onto the upper rim of the well portions 104 of the well structures 103 when entering a well structure 103 by means of the present invention's sample section handling device 1. The distance S between the protection plate 4′ and the most distant apex A of the nub 3 essentially corresponds to a height H of the wall portion 104 as measured from the bottom portion 106 of the well structures 103 or well 103 of the investigation site 105 to its upper or most distant end from the bottom portion 106.

Said distance S and the mechanical properties of the protection plate 4′ may be chosen in relation to the height H of the wall portion 104, the mechanical properties of the nub 3, and/or the mechanical properties of the bottom portion 106 of the well structure 103 and of the underlying sample section 10.

FIGS. 9A to 8D illustrate by means of perspective side views a sample section handling kit 100 with a storage means 20 serving as a stand, wherein the present invention's underlying sample section handling device 1 comprises resilient and/or biasing means 4 for restricting pressure and force exerted on the sample section and/or an investigation stage 105 or site 105, wherein the resilient means 4 is comparable to some extent to the resilient and/or biasing means 4 as shown in embodiment according to FIG. 1.

FIGS. 10A and 10B illustrate by means of a perspective side view and a plan view, respectively, properties of an investigation site 105 for providing a smooth and temperature-controlled surface as a bottom portion 106 of a well structure 103 for improved and stable sample section transfer. In this regard the bottom portion 106 of the well structure 103 may be a cool and thus heat conductive but nevertheless comparable soft material.

These and further aspects of the present invention will also be described in detail in the following passages:

Cryo-sectioning and other sectioning methods provide processes, in which thin sample sections 10 and in particular tissue sections 10 are (a) generated from a frozen or otherwise fixed sample or tissue block and are (b) transferred e.g. to an object slide in a cryotome for later analysis (e.g. in-situ hybridization or immunohistochemistry).

During cryo-sectioning of frozen tissue blocks or micro-sectioning of sample blocks treated with formalin, paraffin, and/or other fixing agents, generated tissue sections 10 as such are usually transferred with one or more general brushes from the cutting plate to an object slide or any other investigation stage or means.

One disadvantage of such a process is that, inter alia the placement of the tissue or sample sections is sometimes difficult because tissue or sample sections 10 do not attach/stick to brushes, brush hairs can damage the tissue or sample sections 10, and tissue or sample sections 10 sometimes arrive on object slides with foldings/wrinkles when using brushes.

Furthermore, stretching of the sample sections 10 with brushes during the transfer process sometimes changes the tissue morphology, e.g. when treating lung tissue with many holes.

Using brushes in combination with sharp blades that are part of a cryotome, can also lead to contamination of analysis samples and slides by small hair residues.

Furthermore, cleaning and disinfection of brushes is inconvenient since brush hairs are drying slower than other materials. Therefore, a disturbing contamination of the sample sections 10 with RNases is more likely to occur.

For some analysis processes, sample sections 10 need to be transferred into reaction wells to treat tissues with different buffers on an object slide. The usual placement method with common brushes is not applicable to fill the reaction wells with sample sections 10. The sample sections 10 need to be pressed/pushed into the wells with the brush, which is not possible for several reasons. For example, the tips of brush hairs may damage the thin tissue sections 10 during such a transfer process known in the art.

Furthermore, the polymer walls of the wells often show an electrostatic charge. Therefore, the sample sections 10 often gravitate to the walls of the wells melt there and are lost for analysis.

To solve the described problems of prior art section and cryo-sectioning processes using common brushes or the like, an alternative technique for sample section handling and transfer and for tissue placement on object slides, pre-assembled slides, or on any other investigation and/or treatment site is presented according to the present invention.

According to the present invention, a sample section handling tool or device 1 is presented which is better suitable for sample section placement and which may primarily focus on the usage of a nub 3 or rubber nub 3 or the like.

For sample section transfer and/or placement, the nub 3 or rubber nub 3 may preferably at least shortly be cooled e.g. on a cold metal plate inside of an underlying cryotome or microtome all within an underlying storage means 20. Then, the nub 3 is carefully pushed on the sample section 10 and the sample section 10 is then thereby transferred to a slide or a reaction well, at which the rubber nub 3, containing the sample section 10, is carefully pressed on the assigned/desired location on the slide or any other required site. Afterwards, the sample section 10 may be warmed up with a fingertip or any other means from the back surface side of the slide.

Using the present invention's sample section handling device 10—which according to the present invention may be formed like a pen or the like-one or plural of the following advantages may simultaneously arise, namely that:
(1) the process of transfer of sample sections 10 is simplified,
(2) the original morphology in the sample sections 10 after the sectioning process is maintained and is kept unchanged,
(3) the sample section 10 can be transferred in a straight and/or flat condition,
(4) the material quality and in particular any tissue quality in the sample section 10 is conserved,
(5) contamination of the sample section 10, in particular with hairs from or by brushes, is reduced or even avoided,
(6) contamination of the sample section 10 with RNases is reduced due to simplified cleaning and disinfection, and
(7) pre-assembled slides can be filled with sample sections 10.

Normally, small general brushes are used for the transfer of cryo-sections onto the object slide, this is inter alia described in e.g. Ross, M. A., Kohut, L., & Loughran, P. A. (2022). Cryosectioning. Current Protocols, 2, e342.

As mentioned above, the disadvantages of conventional sample transfer and placement methods using brushes for tissue transfer and manipulation are inter alia that:
(A) the sample sections cannot be transferred into reaction wells of pre-assembled slides,
(B) hairs of the used brushes can damage the sample sections,
(C) sample sections 10 and in particular tissue sections 10 more likely occur to arrive on object slides with foldings and/or wrinkles leading to blurriness during microscopy,
(D) the transfer with conventional brushes has the risk of changing the material or tissue morphology, e.g. in connection with lung tissue having many holes,
(E) the analysis samples and slides can get contaminated by small hair residues or by residues attached to the hairs of the brush, and
(F) cleaning and disinfection of brushes are inconvenient, thus increasing the risk of contamination of the samples with RNases.

In one embodiment, the present invention comprises a rod as a main body 2 at the tip end 1a, 2a of which a rubber nub 3 is attached. The rod can be made of a solid and stable material (metal or wood or something similar), it can have a length or longitudinal extension in the extension direction X between 5 cm and 13 cm, and it may be cylindrically shaped. The width of the rod 2 may be between 0.8 cm and 1.3 cm. The width of the rod 2 may be larger and may be set e.g. depending on the application. For larger sample sections 10 or tissue sections 10, a larger width may be possible. The entire tool 1 can have a weight and size so that it is suitable for the application, in particular for an operation by the hand of a human or of a robot operator.

The nub 3 can be attached at least to one end 2a of the rod 2 as an elongated body 2 and should preferably be comparable or very elastic, soft and roundly shaped, e.g. when compared to material of the body 2.

The material 3′ of the nub 3 may be suitable for sample or tissue transfer. The suitability can be easily tested.

The rubber nub 3 may be exchangeable or replaceable so that one may clean or substitute the rubber nub 3.

The material 3′ of the nub 3 and its physical properties may be designed, selected and/or changed depending on the application, e.g. taking into consideration the use in connection with different sample materials and tissues.

For pre-cooling the tool or device 1 according to the present invention, a metallic cuboid with a hole on one side where the tool can fit can be used as storage means 20 of the present invention's kit 100 and would be convenient to be installed in connection with the present invention's kit 100 for sample section handling. Such an arrangement can be stored or installed in an underlying cryotome, microtome, or any other sectioning arrangement and can additionally be used as a rack or receptacle for the tool or device 1.

Optionally, for the placement of sections 10 in reaction wells, and according to a preferred embodiment of the present invention, an additional part or means can be installed in connection with the rod 2 or elongated body 2 which is configured in order to inhibit the force exerted by the tool or device 1 in order to avoid breakage of the glass due to the exertion of too much pressure of force. For example, a spring system or any resilient means with a certain bias force may reduce the risk of slide breakage or tissue damages.

In addition to the foregoing description of the present invention, for an additional disclosure explicit reference is taken to graphical representation of FIGS. 1 to 10.

### LIST OF REFERENCE SIGNS

1 sample and/or specimen section handling device and/or tool
1a first end, tip end
1b second end, actuator end
2 (elongated) body, main body, or body portion
2a tip portion, first end portion
2b actuator portion, second end portion
2c gripping portion, central portion
3 nub
3′ material of nub 3
31 in a surface
30 outer surface
3r rim
4 biasing means, resilient means
4 protection plate
5 releasing means
5′ rod
6 charge setting means
7 thermal setting means, cooling means
8 actuator and/or operating means
8′ operating action, operating force, operating pressure
10 sample section
10a upper surface of sample section 10
10b lower surface of sample section 10
20 storage means
21 receptacle means
22 thermal setting means, cooling means
23 charge setting means
100 sample and/or specimen section handling kit, system or arrangement
101 first location on investigation site 105
102 second location on investigation site 105
103 well structure
104 wall portion
105 investigation site
106 bottom portion
A apex of the nub 3 with respect to tip end 2a of body 2
d diameter of body 2
D diameter of nub 3
H height of wall portion 104 of well structure 103
l length of body 2
S distance between protection plate 4′ and apex A of nub 3
X spatial direction
X direction of the longitudinal extension
y spatial direction
Z spatial direction

1. A sample section handling device,
comprising:
an elongated body having a first end formed by a tip portion of the elongated body, and
a nub formed at the tip portion of the elongated body or formed as the tip portion of the elongated body,
wherein the nub has an outer surface that is configured to physically and/or mechanically contact a surface of a sample section for thereby handling and/or manipulating the sample section.

2. The sample section handling device according to claim 1, wherein:
the elongated body has a second end formed by a second end portion of the elongated body, and
the tip portion and thus the first end of the elongated body on the one hand and the second portion and thus the second end of the elongated body on form opposing ends of the elongated body with a central portion of the elongated body disposed therebetween.

3. The sample section handling device according to claim 2, wherein the central portion is configured for being gripped by gripping means of an operator entity.

4. The sample section handling device (1) according to claim 1, wherein the nub and at least its outer surface is/are or is/are formed
by or based on a hollow body, a shell, a jacket, an envelope, a closed sleeve or a hull and in particular essentially has as a shape of a spherical cap, an ellipsoidal cap, a parabolic cap, in particular in case of being free of external forces and/or
to partially or completely have at least one of a convex shape, a concave shape, a round shape, a planar shape, a quadratic shape, a rectangular shape, and a hollow shape of a ring or torus, in particular for low pressure or negative pressure applications.

5. The sample section handling device according to claim 1, wherein:
the nub comprises an inner surface and a rim,
the outer surface of the nub and the inner surface are opposed to each other and are connected to each other by said rim,
the inner surface faces the tip portion of the elongated body, and
the rim physically and/or mechanically contacts and is thus adjacent to the elongated body and/or the tip portion thereof.

6. The sample section handling device according to claim 1, wherein the nub and at least its outer surface is or is formed by or based on a material which is at least one of:
mechanically flexible and/or resilient,
electrically conducting,
thermally conducting,
chemically inert, and
wettable.

7. The sample section handling device according to claim 1, wherein the nub and at least its outer surface is or is formed by or based on a material which is or comprises at least one of:
a rubber material,
a silicone material,
a polymer material,
a plastic or synthetic material,
an elastomer material,
a material coated with or having incorporated a metal material, in particular aluminum,
woven material,
a woven tissue material,
a hybrid material, in particular having various segments,
a hybrid mixed material,
a heat conductive material,
a electrically conductive material,
a gas or air permeable material,
a hydrophilic material,
a hydrophobic material,
a coated material,
a structured and/or textured material, in particular offering at least one of a corrugated surface, dotted surface, and meshed surface,
and
a material having properties surface roughness, friction, adhesion, wettability, and/or flexibility which are in particular adapted and suitably and appropriately set for (a) vertically transferring, in particular by lifting/dragging and dropping, and/or for (b) laterally transferring, in particular by pushing, a sample section.

8. The sample section handling device according to claim 1, comprising at least one of:
biasing and/or resilient means for limiting mechanical pressure and/or force exerted by the nub on a sample section upon physical and/or mechanical contact,
releasing means for releasing a physical and/or mechanical contact of the nub to a sample section,
charge setting means for controllably setting and in particular removing and/or compensating an electrical charge on the nub, on the outer surface of the nub, and/or on a sample section and its surface n physical and/or mechanical contact with the nub,
thermal setting means for controllably cooling and/or heating the nub, the outer surface of the nub, and/or a sample section in physical and/or mechanical contact with the nub, and
actuator and/operating means for controllably operating at least one of the biasing and/or resilient means, the releasing means, the discharging means, and the thermal setting means.

9. The sample section handling device according to claim 1, wherein the body or elongated body
comprises at least one of:
a cylindrical shape,
a shape having a polygonal or rectangular cross section,
a hollow body,
a filled body,
a length that is adapted or adaptable in its length, in particular depending on a desired application and/or function,
an ergonomically adapted or adaptable shape,
a material that is at least one of solid, rigid, shapeable,
a polymer material,
a plastic or synthetic material,
a metal material,
a wood or wooden material,
a glass material, and/or
is configured to be at least one of:
thermally adapted or adaptable, in particular to be cooled,
controlled or controllable by means of pressurized gas or air, in particular with hollow inner portion and an open tip end and/or with a pipette-function,
controlled/operated or controllable/operable by electrical means and/or by means of an inverter,
controlled or controllable by means of an elastic or spring-loaded element, in particular arranged in an inner hollow portion,
filled or fillable with a fluid or liquid for thermal adaptation, in particular for cooling, and
filled or fillable with an aqueous solution, in particular for delivering and/or accepting a drop of solution and a sample section and/or for a formalin-fixed paraffin-embedded environment.

10. The sample section handling device according to claim 1, wherein the first end and/or the tip portion of the elongated body comprises a restriction guide which is configured in order to fit into an investigation site and in particular into an inner dimension of a well and/or to direct the sample section handling device or at least its first end and/or its tip portion to place a sample section at an investigation site and in particular at a center of a well.

11. The sample section handling device according to claim 1, wherein the first end and/or the tip portion of the elongated body is or comprises a removable or replaceable member.

12. A sample section handling kit, comprising:
a sample section handling device comprising:
an elongated body having a first end formed by a tip portion of the elongated body, and
a nub formed at the tip portion of the elongated body or formed as the tip portion of the elongated body,
wherein the nub has an outer surface that is configured to physically and/or mechanically contact a surface of a sample section for thereby handling and/or manipulating the sample section, and
a storage means which is configured to receive and/or to release the sample section handling device, in particular in a controllable manner and/or by having receptacle means.

13. The sample section handling kit according to claim 12, comprising thermal setting means which is:
configured to cool and/or heat the sample section handling device, in particular its first end, its tip portion, its nub and/or its outer surface and/or in a controllable manner, and
which in particular is a component of the receptacle means.

14. The sample section handling kit according to claim 12, comprising charge setting means which is:
configured to set and in particular to remove and/or to compensate an electrical charge on the first end of the elongated body, on its tip portion, on the nub, on the outer surface of the nub, and/or in a controllable manner, and
which in particular is a component of the receptacle means.

15. Usage of a sample section handling device in a method of handling a sample section, wherein:
the sample section handling device comprises:
an elongated body having a first end formed by a tip portion of the elongated body, and
a nub formed at the tip portion of the elongated body or formed as the tip portion of the elongated body,
wherein the nub has an outer surface that is configured to physically and/or mechanically contact a surface of the sample section for thereby handling and/or manipulating the sample section, and
the method of handling the sample section comprises at least one of vertically transferring, in particular by lifting/dragging and dropping, and of laterally transferring, in particular by pushing, a sample section.

16-18. (canceled)
